(19) United States
(12) Patent Application Publication
(10) Pub. No.: US 2024/0273356 A1
(43) Pub. Date: Aug. 15, 2024

(54) DATA PROCESSING METHOD FOR A NEURAL NETWORK

(71) Applicant: MONTAGE TECHNOLOGY CO., LTD., Shanghai (CN)

(72) Inventors: Qian WU, Shanghai (CN); Ming LI, Shanghai (CN); Qi XU, Shanghai (CN)

(21) Appl. No.: 18/433,358

(22) Filed: Feb. 5, 2024

(30) Foreign Application Priority Data
Feb. 10, 2023 (CN) 202310108689.9

(51) Int. Cl. G06N 3/08

(52) U.S. Cl. CPC G06N 3/08

(57) ABSTRACT

A data processing method for a neural network implemented by a computing device and comprises a plurality of layers, the computing device comprises a first and a second memory, weight data of each of the plurality of layers is stored in the second memory, input data and output data have respective predetermined storage locations, the method comprises: performing batch processing to input data and weight data with a predetermined batch size; the predetermined batch size is determined using the following steps: determining actual storage locations of the input data and the output data of each layer when data is processed in batches using batch size candidates; determining memory access conditions of the second memory for each layer when data is processed in batches using batch size candidates; determining total memory access amount of the neural network corresponding to batch size candidates; selecting the predetermined batch size.

### TECHNICAL FIELD

This application relates to neural network technology, and more specifically, to a data processing method for a neural network.

### BACKGROUND OF THE INVENTION

In artificial intelligence (AI) application scenarios, neural network is a commonly used AI method. The computational performance of a computing platform is usually determined by a combination of data, neural network models, and hardware conditions, etc. Theoretically, a maximum computational performance of a computing platform can be evaluated by the roof-line model. According to the roof-line model, when the computing platform is in a communication-bounded region, the computational performance can be improved by increasing the computational density which is computation to communication ratio (CCR); and when the computing platform is in a computation-bounded region, the computational performance can be improved by increasing the computing power of the computing platform. Typically, computing power resources are more abundant than memory resources. Therefore, the computing platform is usually more likely to be in the communication-bounded region and needs to increase the computational density CCR to improve the computational performance.

For different neural network models, each layer may have a respective computational density, and the non-uniform computational densities can significantly affect the overall computational performance of the neural network models. Current roof-line model generally focuses on modeling and optimizing each layer, which ignores the overall inter-layer relationship of the neural network models. The individual layer optimization does not lead to optimization of the overall computational performance.

In view of this, there is a need for further improvement of data processing methods applicable to neural networks.

### SUMMARY OF THE INVENTION

One objective of the present application is to provide a data processing method for a neural network to address the problem of low overall computational density of neural network models.

According to one aspect of the present application, a data processing method for a neural network is provided, the neural network is implemented by a computing device and comprises a plurality of layers, the computing device comprises a first memory and a second memory, weight data of each layer of the plurality of layers is stored in the second memory, input data and output data of each layer of the plurality of layers have respective predetermined storage locations, the predetermined storage locations being the first memory or the second memory, and the method comprises: performing batch processing by each layer of the plurality of layers to the input data and weight data of the layer with a predetermined batch size; wherein the predetermined batch size is determined using the following steps: determining, according to the predetermined storage locations corresponding to the input data and the output data of each layer of the plurality of layers, and a relationship between a required storage space and a storage space of the predetermined storage locations, actual storage locations of the input data and the output data of each layer when data is processed in batches using batch size candidates; determining, according to the determined actual storage locations, respective memory access conditions of the second memory for each layer of the plurality of layers when data is processed in batches using the batch size candidates; determining, according to the determined respective memory access conditions corresponding to the batch size candidates, respective total memory access amounts of the neural network corresponding to the batch size candidates; and selecting, according to the respective total memory access amounts of the neural network corresponding to the batch size candidates and a predetermined batch size selection rule, the predetermined batch size from the batch size candidates.

According to another aspect of the present application, a method for determining a batch size for a neural network to process data in batches is provided, wherein the neural network is implemented by a computing device and comprises a plurality of layers, the computing device comprises a first memory and a second memory, weight data of each layer of the plurality of layers is stored in the second memory, input data and output data of each layer of the plurality of layers have respective predetermined storage locations, the predetermined storage locations being the first memory or the second memory, and the method comprises: determining, according to the predetermined storage locations corresponding to the input data and the output data of each layer of the plurality of layers, and a relationship between a required storage space and a storage space of the predetermined storage locations, actual storage locations of the input data and the output data of each layer when data is processed in batches using batch size candidates; determining, according to the determined actual storage locations, respective memory access conditions of the second memory for each layer of the plurality of layers when data is processed in batches using the batch size candidates; determining, according to the determined respective memory access conditions corresponding to the batch size candidates, respective total memory access amounts of the neural network corresponding to the batch size candidates; and selecting, according to the respective total memory access amounts of the neural network corresponding to the batch size candidates and a predetermined batch size selection rule, a predetermined batch size from the batch size candidates.

The above is an overview of the application, and may be simplified, summarized and omitted in detail. Therefore, those skilled in the art should realize that this part is only illustrative, and is not intended to limit the scope of the application in any way. This summary section is neither intended to determine the key features or essential features of the claimed subject matter, nor is it intended to be used as an auxiliary means to determine the scope of the claimed subject matter.

### BRIEF DESCRIPTION OF DRAWINGS

Through the following detailed description in conjunction with the accompanying drawings and the appended claims, those skilled in the art will more fully understand the above and other features of the content of this application. It can be understood that these drawings and detailed description only depict several exemplary embodiments of the content of the present application, and should not be considered as limiting the scope of the content of the present application. By referring to the drawings, the content of this application will be explained more clearly and in detail.

FIG. 1 shows a schematic diagram of a data flow of a computing device.

FIG. 2 shows a flowchart of a method for determining a batch size for a neural network to process data in batches according to an embodiment of the present application.

FIGS. 3a to 6b show schematic diagram of accessing memory of a neural network processing data in batches according to several embodiments of the present application.

### DETAILED DESCRIPTION OF THE INVENTION

In the following detailed description, reference is made to the drawings constituting a part of the specification. In the drawings, unless the context dictates otherwise, similar symbols usually indicate similar components. The illustrative embodiments described in the detailed description, drawings, and claims are not meant to be limiting. Without departing from the spirit or scope of the subject matter of the present application, other implementation modes can be adopted and other changes can be made. It can be understood that various aspects of the content of the application generally described in the application and illustrated in the drawings can be configured, replaced, combined, and designed with various different configurations, and all of these clearly constitute part of the content of the application.

In some embodiments of the present application, object data which is expected to be processed by a neural network refers to raw data processed by a computing device. The object data may include multiple batches of data samples, and each batch may include multiple data samples (the case of each batch including one data sample is equivalent to single data sample being processed one by one). For example, a scenario of data processing using a neural network is that a first layer of a neural network uses weight parameters (hereafter also referred to as “weight data”) of the first layer to process a batch of data samples of the object data (the batch of data samples constitutes input data of the first layer) to obtain output data of the first layer. Thereafter, all or a part of the output data of the first layer is processed as input data of a second layer by weight parameters of the second layer to obtain output data of the second layer. The processing may be repeated for the other layers. In addition, the present application does not limit whether or not the neural network includes a branching structure. For example, ResNet Inception v3, etc. with a branching structure or a Visual Geometry Group (VGG) model, etc. without a branching structure all fall within the protection scope of the present application.

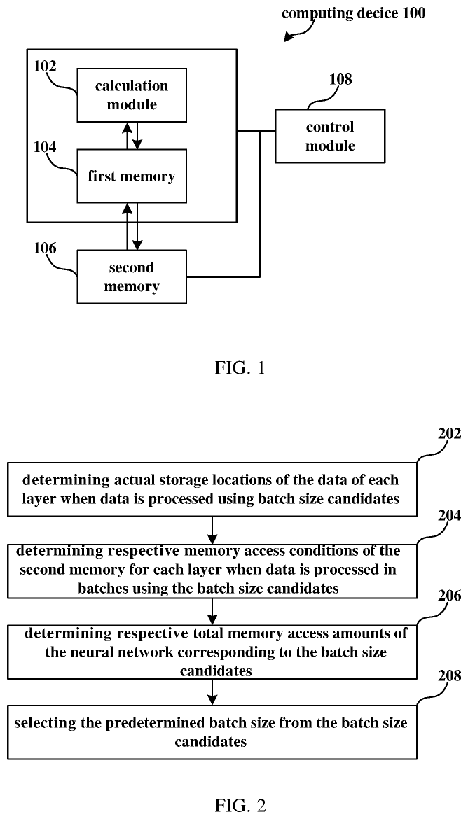

FIG. 1 illustrates a schematic diagram of a computing device 100 according to an embodiment of the present application. In some embodiments, the computing device 100 may be used to implement data processing by a neural network model. Specifically, training of a neural network model can be configured and implemented by the computing device 100, and inference of data by a neural network algorithm can be configured and implemented by the computing device 100. As shown in FIG. 1, the computing device 100 may include a calculation module 102 for performing data calculations (or operations), a first memory 104 connected to the calculation module 102, and a second memory 106. Herein, the first memory 104 may be integrated with the calculation module 102; and the first memory 104 and the second memory 106 are connected with each other, and have a certain amount of storage space, respectively. Depending on different circumstances, at least a portion of each of the first memory 104 and/or the second memory 106 may be used for storing input data or output data; and at least a portion of each of the first memory 104 and/or the second memory 106 may also be used for storing other data, such as weight parameters required for neural network operations. It can be understood that since the first memory 104 is integrated with the calculation module 102, compared to the second memory 106, the data interaction speed between the first memory 104 and the calculation module 102 is higher, and thus data can be stored preferably in the first memory 104. When there is not enough storage space in the first memory 104, then data can be stored in the second memory 106. It can be understood that in some embodiments, the first memory 104 may not be integrated with the calculation module 102, but the first memory 104 may still have a higher priority than the second memory 106.

Still referring to FIG. 1, the computing device 100 may further include a control module 108, and the control module 108 may control the calculation module 102, the first memory 104, and the second memory 106. Specifically, the control module 108 may control data interactions among all three or two of the calculation module 102, the first memory 104 and the second memory 106. For example, the integrated calculation module 102 and the first memory 104 may be controlled by the control module 108 using one control signal, and the second memory 106 may be controlled by the control module 108 using another control signal.

Note that only one exemplary architecture of the computing device 100 is illustrated above. Depending on different specific embodiments, the computing device may adopt other architectures. In some embodiments, the calculation module 102 and the first memory 104 are integrated also with other modules. In yet other embodiments, the control module 108 controls the calculation module 102, the first memory 104, and the second memory 106 using different control signals, respectively. In yet further embodiments, the calculation module 102, the first memory 104, and the second memory 106 may be integrated together, or all three may directly perform data transfers to each other, but the amount of memory access of the computing system still refers to the amount of data interactions resulting from the access to the second memory.

In some embodiments, a neural network performs operations on the object data in the computing device 100. Specifically, a neural network may include multiple layers, e.g., for a convolutional neural network, it may include convolutional layer(s), pooling layer(s), activation layer(s), fully-connected layer(s), and the like. Some of the layers such as the convolutional layers and the fully-connected layers of the neural network have weight parameters. Taking the convolutional layers as an example, each convolutional layer processes the input data with a set of weight parameters to obtain the output data. Generally, the weight parameters involved in each convolutional layer are stored in the second memory, and there may be various cases for the storage locations of the input data and output data.

In an embodiment, when the calculation module 102 of the computing device 100 performs operations, the input data of the calculation module 102 may come from the first memory 104 or the second memory 106, and the output data may also be stored in the first memory 104 or the second memory 106. The weight parameters are stored in the second memory 106. When operation of each layer is performed, the weight data of the layer can be loaded from the second memory 106 to the first memory 104, so that the calculation module can obtain the weight data from the first memory 104 to perform calculations (or operations).

The source of the input data can be as described below. In some embodiments, all of the input data may come from the first memory 104. In some other embodiments, the input data may come from the second memory 106. When the input data needs to be processed, it may be loaded from the second memory 106 to the first memory 104 for calculation by the calculation module. During loading, all data can be loaded from the second memory 106 to the first memory 104 at once, or data may be loaded in batches from the second memory 106 to the first memory 104, i.e., in a partial loading manner.

The storage of output data is similar to that of the input data, with an opposite path of data transfer. For example, in some embodiments, all of the output data can be stored in the first memory 104, while in some other embodiments, the output data processed by the calculation module 102 is output to the first memory 104 and then transferred from the first memory 104 to the second memory 106 for storage.

It can be understood that input data of the first layer of a neural network may come from the second memory 106, and input data of other layers may come from the first memory 104 or the second memory 106 as mentioned above.

In some embodiments, the calculation module 102 may be a process element (PE) array in an artificial intelligence (AI) accelerator, the first memory 104 may be an on-chip memory of the calculation module 102, and the second memory 106 may be an off-chip memory. In some embodiments, the first memory 104 is a static random-access memory (SRAM), and the second memory 106 is a double data rate (DDR) synchronous dynamic random access memory. In general, the on-chip memory has a smaller storage space but is faster in data accessing, and the off-chip memory has a larger storage space but is slower in data accessing. For ease of illustration, hereinafter, the on-chip memory and the off-chip memory are used to represent the first memory 104 and the second memory 106, respectively, but should not be taken as a limitation of the present application.

It should be noted that, since the access speed to the off-chip memory is relatively slow, the access to the off-chip memory takes up a longer period of time, which is significantly greater than the time taken for the access to the on-chip memory. Accordingly, in some embodiments of the present application, the calculation of the amount of memory access only takes into account accesses to the off-chip memory and does not take into account accesses to the on-chip memory.

The inventors of the present application have found out that, considering the overall inter-layer relationship, the computational density (number of calculations that can be performed per byte of memory exchange) of the overall neural network model is related to the batch size, and by increasing the batch size, the computational density can be increased, resulting in a higher overall computational performance. However, in practical computing, the space of an on-chip memory is limited, and increasing too much the batch size may result in the need to store the input data and output data to the off-chip memory, which leads to an increase in the amount of memory access to the off-chip memory, and the increase in the amount of memory access to the off-chip memory may reduce the computational density. Therefore, how to select an appropriate batch size is critical. In order to resolve this problem, the inventors of the present application propose a method for evaluating and selecting a batch size candidate that balances between an increase in computational density and an increase in the amount of memory access caused by an increase in the batch size.

FIG. 2 shows a flowchart for evaluating batch size candidates according to an embodiment of the present application.

As shown in FIG. 2, in step 202, according to predetermined storage locations corresponding to the input data, the output data of each layer of the plurality of layers of the neural network, and a relationship between the required storage space and the storage space of the predetermined storage locations, it is determined that actual storage locations of the input data and the output data of each layer when data is processed in batches using batch size candidates; In step 204, according to the determined actual storage locations, it is determined that memory access conditions of the second memory for each layer of the plurality of layers when data is processed in batches using batch size candidates. In step 206, according to the determined respective memory access conditions corresponding to the batch size candidates, it is determined that respective total memory access amounts of the neural network corresponding to batch size candidates. In step 208, according to the respective total memory access amounts of the neural network corresponding to the batch size candidates and a predetermined batch size selection rule, the predetermined batch size is selected from the batch size candidates. In some embodiments, the selected predetermined batch size may maximize the computational density of the data processing performed by the neural network. It will be appreciated that one of the multiple batch sizes corresponding to a relatively optimal (rather than maximum) computational density may also be selected. For example, other properties associated with different batch sizes, such as arithmetic delays, etc., may also be considered when selecting a batch size.

As described above, each of the input data and the output data of each layer has a predetermined storage location, which indicates a predetermined target location for data storage. However, when data is processed with different batch sizes, the storage space required for the input data and the output data may change. In general, the larger the batch size is, the larger the storage space required for the input data and the output data is. It is not certain whether the storage space of the predetermined storage location is able to satisfy the storage space required for the input data and output data under the current batch size, and in that case, it may be desired to adjust the storage locations of the input data and the output data, i.e., the predetermined storage locations of the input data and the output data may not necessarily be the actual storage locations of the input data and output data.

According to predetermined storage locations of the input data and the output data corresponding to a layer of the neural network, and a storage space of the on-chip memory and the off-chip memory, memory access condition of the off-chip memory can be determined. Therefore, the amount of memory access of the layer to the off-chip memory can be determined by calculation. Herein, the memory access condition to the off-chip memory of a layer is the data interaction condition with the off-chip memory when the layer processes data. Specifically, the calculation of the amount of memory access can be categorized into the four cases below.

### Case 1: The Input Data and the Output Data are Predetermined to be Stored in the Off-Chip Memory

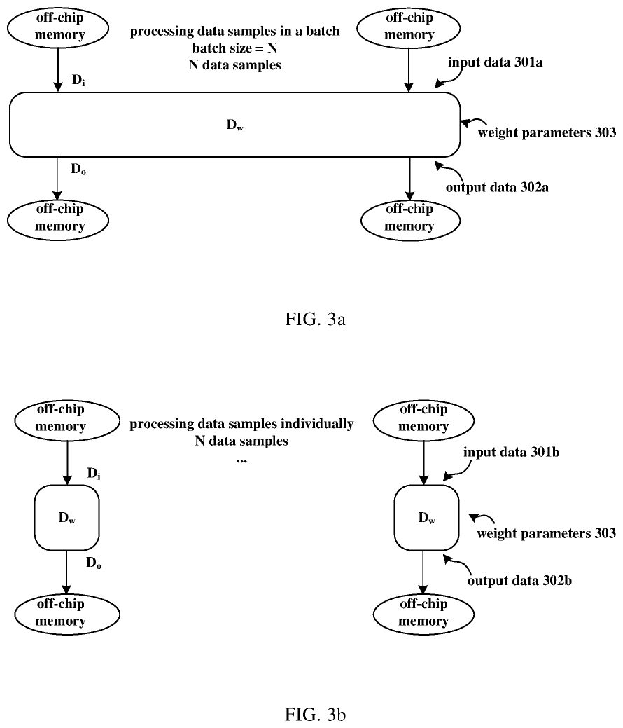

FIGS. 3a and 3b illustrate schematic diagrams in which both the input data 301a (or 301b) and the output data 302a (or 302b) of a layer are predetermined to be stored in the off-chip memory when data samples are processed in a batch (i.e., adopting batch processing) and when data samples are processed individually (i.e., not adopting batch processing, or partial processing), respectively. FIG. 3a illustrates, for a batch size candidate N, the amount of memory access of one of the layers when N data samples are correspondingly processed through the neural network. The amount of memory access of the layer includes the amount of memory access of the weight parameters 303 for one time, the amount of memory access of the input data 301a and the amount of memory access of the output data 302a of the layer corresponding to the N data samples, which is expressed by Equation (1) as follows:

$${D}_{batch \_ layer} = N * ( {D}_{i} + {D}_{o} ) + {D}_{W} \qquad Equation ( 1 )$$

wherein D_{batch_layer} denotes the amount of memory access of the layer that performs data processing with batch size=N, where N is a positive integer greater than 1, Dᵢ is the amount of memory access of reading the input data of the layer corresponding to one data sample, Dₒ is the amount of memory access of storing the output data of the layer corresponding to one data sample, and D_{w} is the amount of memory access of reading the weight parameters 303 of the layer. In Equation (1), since data is processed in batches, in the batch processing of batch size N, the weight parameters need to be read only once, and the corresponding amount of memory access is D_{w}, and the amount of memory access for reading the input data corresponding to N data samples is N*Dᵢ, and the amount of memory access for storing the output data corresponding to N data samples is N*Dₒ.

Correspondingly, when not adopting batch input, the N data samples need to undergo the data processing by the neural network for N times. Referring to FIG. 3b, in the case of not adopting batch input, the amount of memory access of the layer is the amount of memory access to the off-chip memory of the layer when the N data samples are processed one by one through the neural network. Specifically, the amount of memory access of the layer includes the amount of memory access of the weight parameters 303 for N times as well as N times of the amount of memory access of the input data 301b and N times of the amount of memory access of the output data 302b, i.e., as expressed by Equation (2) as follows:

$${D}_{non \_ batch \_ layer} = N * ( {D}_{i} + {D}_{o} + {D}_{W} ) \qquad Equation ( 2 )$$

wherein D_{non_batch_layer} represents the amount of memory access of a layer when N data samples are processed not adopting batch input, Dᵢ is the amount of memory access of the layer reading the input data corresponding to one data sample, Dₒ is the amount of memory access of the layer storing the output data corresponding to one data sample, and D_{w} is the amount of memory access of reading the weight parameters 303 of the layer corresponding to one data sample.

### Case 2: The Input Data is Predetermined to be Stored in the Off-Chip Memory, the Output Data is Predetermined to be Stored in the On-Chip Memory

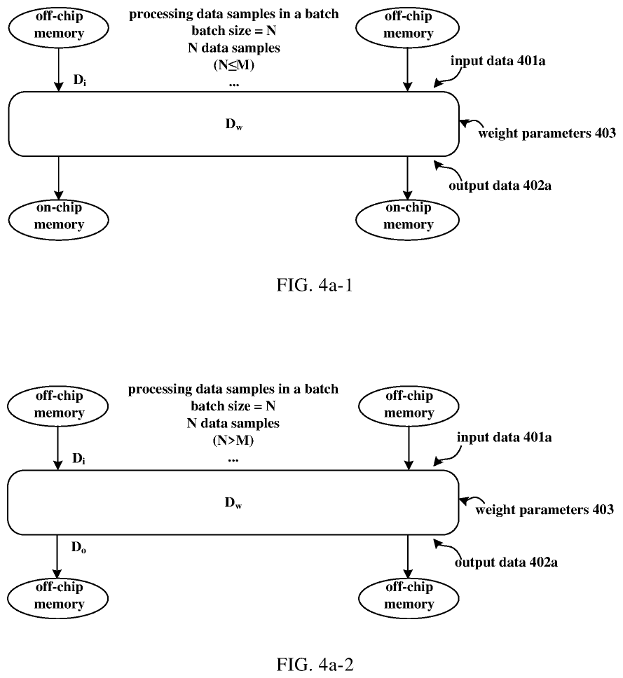

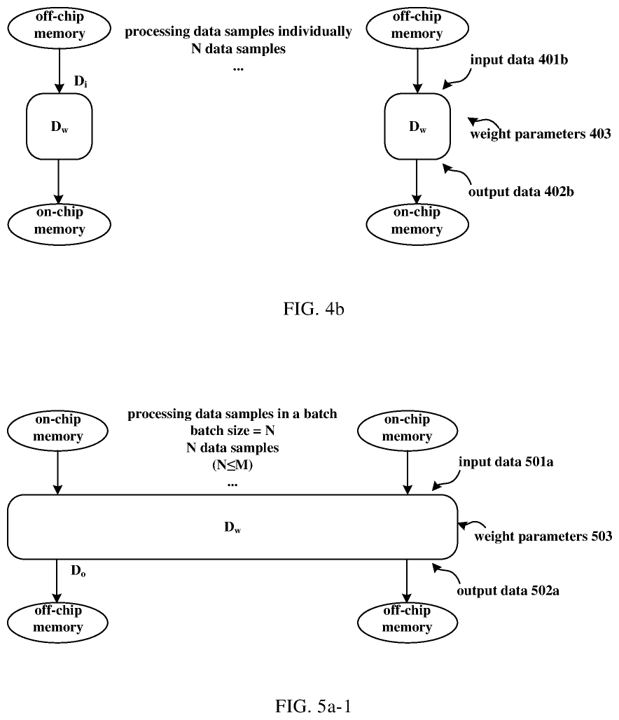

FIG. 4a-1 illustrates a schematic diagram in which the input data 401a of a layer is stored in the off-chip memory and the output data 402a is stored in the on-chip memory when data samples are processed in a batch (i.e., adopting batch processing). At this time, the amount of memory access of the layer includes an amount of memory access of the weight parameters 403 for one time, the amount of memory access of the input data 401a and the amount of memory access of the output data 402a of the layer. When all the output data 402a is stored in the on-chip memory, its amount of memory access is very few which is negligible.

In addition, it should be noted that if adopting batch size N, the storage space of the on-chip memory is smaller than the storage space required for the output data 402a of the layer. For example, the maximum batch size corresponding to the storage space of the on-chip memory is M_{output_on} (M_{output_on} is an integer greater than 0), and N>M_{output_on}, that is to say, the on-chip memory is unable to accommodate all of the output data 402a. In that case, as shown in FIG. 4a-2, the output data 402a still needs to be stored in the off-chip memory. FIG. 4a-2 illustrates a schematic diagram in which the input data 401a of a layer is stored in the off-chip memory and the output data 402a is stored in both the on-chip memory and the off-chip memory when data samples are processed in a batch (i.e. adopting batch processing) (i.e., the output data is partially transferred to the on-chip memory and transferred to the off-chip memory via the on-chip memory, until all output data has been stored). In this case, the amount of memory access is the same as that of Case 1, and the amount of memory access of the layer includes an amount of memory access of the weight parameters 403 for one time, the amount of memory access of the input data 401a and the amount of memory access of the output data 402a of the layer.

The amount of memory access of the above two cases is expressed by Equation (3) as follows:

$${D}_{batch \_ layer} = \{ \begin{matrix}N * {D}_{i} + {D}_{W} ( N \leq {M}_{output \_ on} ) \\ N * ( {D}_{i} + {D}_{o} ) + {D}_{W} ( N > {M}_{output \_ on} )\end{matrix} \qquad Equation ( 3 )$$

wherein, M_{output_on} corresponds to the maximum batch size of the output data that the on-chip memory can store (hardware resource limit or storage space that the system can allocate). If the currently selected batch size N is less than or equal to M_{output_on}, then all the output data can be stored in the on-chip memory, otherwise all the output data need to be stored in the off-chip memory. For different layers, this maximum batch size may change. In some embodiments, each layer may have a respective maximum batch size value. In yet other embodiments, the same maximum batch size M is adopted for the overall neural network.

Correspondingly, when data samples are processed individually, (i.e., not adopting batch processing), N data samples need to be processed through the neural network sample by sample. FIG. 4b illustrates a schematic diagram in which the input data 401a of a layer is stored in the off-chip memory and the output data 402a is stored in the on-chip memory when not adopting batch processing. Referring to FIG. 4b, when data samples are processed individually, (i.e., not adopting batch processing), the amount of memory access of the layer includes the amount of memory access of the weight parameters 403 for N times and N times of the amount of memory access of the input data 401b. Since the output data 402b is stored in the on-chip memory, the amount of memory access of the output data 402a is very few and is negligible. That is, the amount of memory access can be expressed by Equation (4) as follows:

$${D}_{non \_ batch \_ layer} = N * ( {D}_{i} + {D}_{W} ) \qquad Equation ( 4 )$$

wherein D_{non_batch_layer} represents the amount of memory access of a layer when N data samples are processed individually (i.e. not adopting batch processing), Dᵢ is the amount of memory access of the layer reading the input data corresponding to one data sample, and D_{w} is the amount of memory access of reading the weight parameters of the layer corresponding to one data sample.

### Case 3: The Input Data is Predetermined to be Stored in the On-Chip Memory, the Output Data is Predetermined to be Stored in the Off-Chip Memory

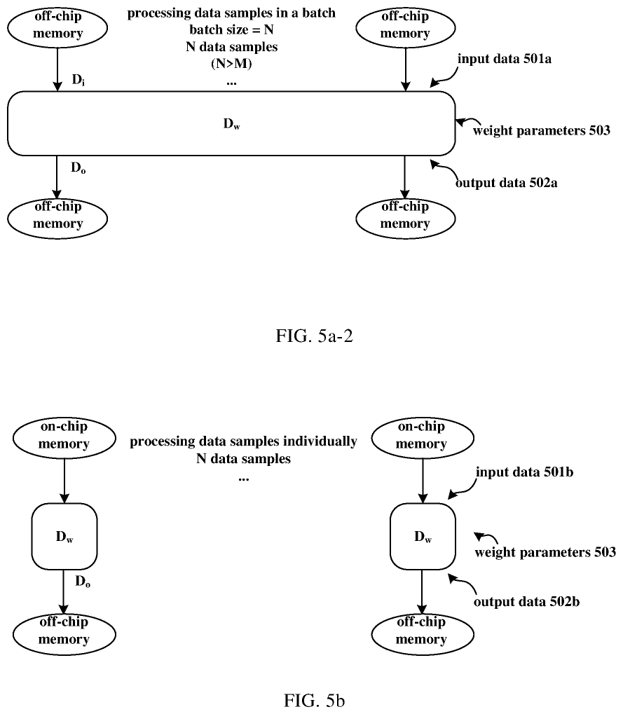

FIG. 5a-1 illustrates a schematic diagram in which the input data 501a of a layer is stored in the on-chip memory and the output data 502a is stored in the off-chip memory when data samples are processed in a batch, (i.e., adopting batch processing). In that case, the amount of memory access of the layer includes an amount of memory access of the weight parameters 503 for one time, the amount of memory access of the output data 502a and the amount of memory access of the input data 501a of the layer. When all the input data 501a is read from the on-chip memory, its amount of memory access is very few which is negligible.

In addition, it should be noted that if adopting batch size N, the storage space of the on-chip memory is smaller than the storage space required for the input data 501a of the layer. For example, the maximum batch size corresponding to the storage space of the on-chip memory is M_{input_on} (M_{input_on} is an integer greater than 0), and N>M_{input_on}, that is to say, the on-chip memory is unable to accommodate all of the input data 501a. In that case, as shown in FIG. 5a-2, the input data 501a still needs to be read from the off-chip memory. FIG. 5a-2 illustrates a schematic diagram in which the output data 502a of a layer is stored in the off-chip memory and the input data 501a is stored in both the on-chip memory and the off-chip memory when data samples are processed in a batch (i.e., adopting batch processing) (i.e., the input data is partially transferred from the off-chip memory to the on-chip memory, until all input data has been processed). In this case, the amount of memory access is the same as that of Case 1, and the amount of memory access of the layer includes an amount of memory access of the weight parameters 503 for one time, the amount of memory access of the input data 501a and the amount of memory access of the output data 502a of the layer.

The amount of memory access of the above two cases are expressed by Equation (5) as follows:

$${D}_{batch \_ layer} = \{ \begin{matrix}N * {D}_{o} + {D}_{W} ( N \leq {M}_{input \_ on} ) \\ N * ( {D}_{i} + {D}_{o} ) + {D}_{W} ( N > {M}_{input \_ on} )\end{matrix} \qquad Equation ( 5 )$$

wherein, M_{input_on} corresponds to the maximum batch size of the input data that the on-chip memory can store (hardware resource limit or storage space that the system can allocate). If the currently selected batch size N is less than or equal to M_{input_on}, then all the input data can read from the on-chip memory, otherwise all the input data need to be read from the off-chip memory. For different layers, this maximum batch size may change. In some embodiments, each layer may have a respective maximum batch size value. In yet other embodiments, the same maximum batch size M is adopted for the overall neural network.

Correspondingly, when data samples are processed individually, (i.e., not adopting batch processing), N data samples need to be processed through the neural network sample by sample. FIG. 5b illustrates a schematic diagram in which the input data 501b of a layer is stored in the on-chip memory and the output data 502b is stored in the off-chip memory when not adopting batch processing. Referring to FIG. 5b, when data samples are processed individually, (i.e., not adopting batch processing), the amount of memory access of the layer includes the amount of memory access of the weight parameters 503 for N times and N times of the amount of memory access of the output data 502b. Since the input data 501b is read from the on-chip memory, the amount of memory access of the input data 501b is very few and is negligible. That is, the amount of memory access can be expressed by Equation (6) as follows:

$${D}_{non \_ batch \_ layer} = N * ( {D}_{o} + {D}_{W} ) \qquad Equation ( 6 )$$

wherein D_{non_batch_layer} represents the amount of memory access of a layer when N data samples are processed individually, (i.e. not adopting batch processing), Dᵢ is the amount of memory access of the layer reading the input data corresponding to one data sample, and D_{w} is the amount of memory access of reading the weight parameters of the layer corresponding to one data sample.

### Case 4: The Input Data is Predetermined to be Stored in the On-Chip Memory, the Output Data is Predetermined to be Stored in the On-Chip Memory

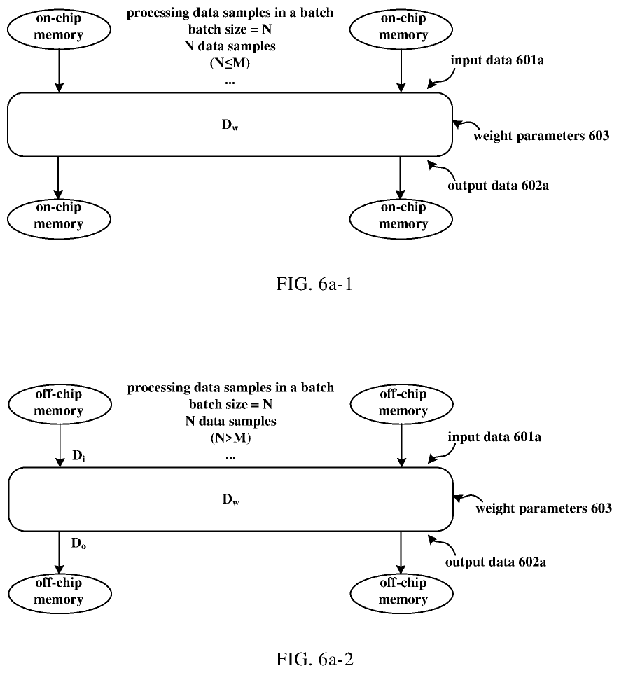

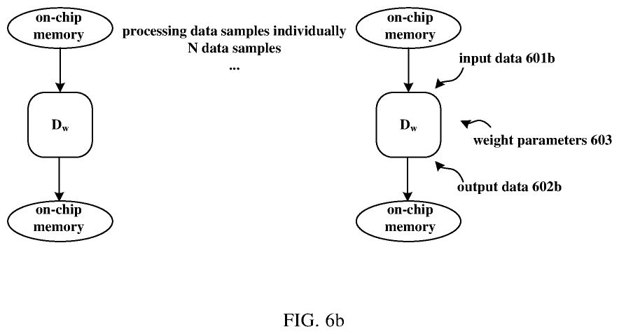

FIG. 6a-1 illustrates a schematic diagram in which both the input data 601a and the output data 602a of a layer is stored in the on-chip memory when data samples are processed in a batch, (i.e., adopting batch processing). In that case, the amount of memory access of the layer includes an amount of memory access of the weight parameters 603 for one time, the amount of memory access of the input data 601a and the output data 602a. When all the input data 601a and the output data 602a are stored in the on-chip memory, its amount of memory access is very few which is negligible.

In addition, it should be noted that if batch size N is adopted, the storage space of the on-chip memory is smaller than the storage space required for the input data 601a or the output data 602a of the layer. For example, the maximum batch size corresponding to the storage space of the on-chip memory is Mₒₙ (Mₒₙ is an integer greater than 0), and N>Mₒₙ, that is to say, the storage space of the on-chip memory is smaller than a greater one of the storage space occupied by the input data 601a and the storage space occupied by the output data 602a. In that case, as shown in FIG. 6a-2, according to the technical solution of the present application, both the input data 601a and the output data 602a are stored in the off-chip memory for memory accessing. FIG. 6a-2 illustrates a schematic diagram in which the input data 601a and the output data 602a of a layer is stored in both the on-chip memory and the off-chip memory when data samples are processed in a batch, (i.e. adopting batch processing) (i.e., the input data is partially transferred from the off-chip memory to the on-chip memory, until all input data has been processed; the output data is partially transferred to the on-chip memory and transferred to the off-chip memory, until all output data has been stored). In this case, the amount of memory access is the same as that of Case 1, and the amount of memory access of the layer includes an amount of memory access of the weight parameters 603 for one time, the amount of memory access of the input data 601a and the amount of memory access of the output data 602a of the layer.

The amount of memory access of the above two cases are expressed by Equation (7) as follows:

$${D}_{batch \_ layer} = \{ \begin{matrix}{D}_{W} ( N \leq {M}_{on} ) \\ N * ( {D}_{i} + {D}_{o} ) + {D}_{W} ( N > {M}_{on} )\end{matrix} \qquad Equation ( 7 )$$

wherein, Mₒₙ corresponds to a smaller one of the two maximum batch sizes of the input data and the output data that the on-chip memory can store (hardware resource limit or storage space that the system can allocate). If the currently selected batch size N is less than or equal to Mₒₙ, then all the input data can read from the on-chip memory, all the output data can be stored to the on-chip memory; otherwise all the input data need to be read from the off-chip memory, all the output data need to be stored to the off-chip memory. For different layers, this maximum batch size may change. In some embodiments, each layer may have a respective maximum batch size value. In yet other embodiments, the same maximum batch size M is adopted for the overall neural network.

Correspondingly, when data samples are processed individually, (i.e., not adopting batch processing), N data samples need to be processed through the neural network sample by sample. FIG. 6b illustrates a schematic diagram in which the input data 601b and the output data 602b of a layer is accessed from the on-chip memory when data samples are processed individually, (i.e., not adopting batch processing). Referring to FIG. 6b, when data samples are processed individually, (i.e., not adopting batch processing), the amount of memory access of the layer includes the amount of memory access of the weight parameters 603 for N times, since the input data 601b and the output data 602b is read from and stored to the on-chip memory, respectively, the amount of memory access is very few and is negligible. That is, the amount of memory access can be expressed by Equation (8) as follows:

$${D}_{non \_ batch \_ layer} = N * {D}_{W} \qquad Equation ( 8 )$$

wherein D_{non_batch_layer} represents the amount of memory access of a layer when N data samples are processed individually (i.e., not adopting batch processing), and D_{w} is the amount of memory access of reading the weight parameters of the layer corresponding to one data sample.

As described in FIG. 2 and the foregoing, after calculating the amount of memory access corresponding to each layer based on the foregoing cases, the total memory access amount corresponding to the neural network can be calculated and determined. Specifically, the total memory access amount D_{batch}_N when data samples are processed in a batch, (i.e., adopting batch processing) using a batch size of N can be obtained by accumulating the amount of memory access D_{batch_layer} corresponding to each layer. Correspondingly, the total memory access amount D_{non_batch}_N for processing N data samples one by one without adopting batch processing can be obtained by accumulating the amount of memory access D_{non_batch_layer} corresponding to each layer.

After obtaining the total memory access amount, an evaluation criterion between the amount of memory access and computational performance improvement can be established. According to the roof-line model, the difference between the computational density CCR of the two cases of processing data samples in a batch (i.e., adopting batch processing) with batch size N and processing data samples individually (i.e., not adopting batch processing) can be calculated, and this difference can be used to measure the computational performance improvement. In some embodiments, the computational density improvement index Δ can use the difference of the computational density CCR, i.e., as expressed by Equation (9) as follows:

$$Δ = C C {R}_{batch} - C C {R}_{non \_ batch} = \frac{N * {Σ}_{i = 0}^{n - 1} {O}_{i}}{{\sum }_{i = 0}^{n - 1} {D}_{batch \_ layer}} \frac{N * {Σ}_{i = 0}^{n - 1} {O}_{i}}{{\sum }_{i = 0}^{n - 1} {D}_{non \_ batch \_ layer}} = N * {Σ}_{i = 0}^{n - 1} {O}_{i} * ( \frac{1}{{\sum }_{i = 0}^{n - 1} {D}_{batch \_ layer}} - \frac{1}{{\sum }_{i = 0}^{n - 1} {D}_{non \_ batch \_ layer}} ) \qquad Equation ( 9 )$$

wherein CCR_{batch} and CCR_{non_batch} denote the computational density CCR when processing data samples in a batch (i.e. adopting batch processing) with batch size N and processing data samples individually (i.e. not adopting batch processing), respectively. In Equation (9), the numerator of each term is the amount of computation of processing N data, Oᵢ denotes the time complexity of data processing one single data sample in the i-th layer, n denotes the number of layers of the network, and the denominator is the total memory access amount.

It can be understood that the item Σᵢ₌₀ⁿ⁻¹Oᵢ of total time complexity for one single data is independent of batch size. In some embodiments, the computational density improvement index Δ can adopt part of the result in Equation (9), i.e., using Equation (10) expressed as follows:

$$Δ = N * ( \frac{1}{{\sum }_{i = 0}^{n - 1} {D}_{batch \_ layer}} - \frac{1}{{\sum }_{i = 0}^{n - 1} {D}_{non \_ batch \_ layer}} ) = N * ( \frac{1}{{D}_{batch} \_N} - \frac{1}{{D}_{non \_ batch} \_N} ) \qquad Equation ( 10 )$$

It can be understood that the denominator of the item

$$\frac{1}{{\sum }_{i = 0}^{n - 1} {D}_{non \_ batch \_ layer}}$$

involving the total memory access amount when processing data samples individually (i.e. without adopting batch processing) is cumulative, and according to cases 1-4 described above, each of the items in this cumulation contains a common factor N. Therefore, the common factor of the denominator may be canceled out with N outside of the parentheses, and the item after cancelation is independent of the batch size N. In some embodiments, the computational density improvement index Δ can adopt part of the result in Equation (10), i.e., using Equation (11) expressed as follows for evaluation.

$$Δ = N * \frac{1}{{\sum }_{i = 0}^{n - 1} {D}_{batch \_ layer}} = N * \frac{l}{{D}_{batch} \_N} \qquad Equation ( 11 )$$

After obtaining the computational density improvement index Δ for each of the batch size candidates, the batch size candidate with the superior computational density improvement index Δ may be selected as the batch size for data processing by the neural network, i.e., to maximize the computational density of the data processing performed by the neural network is a predetermined batch size selection rule used for selecting the batch size from the batch size candidates. It can be understood that in some embodiments, other predetermined batch size selection rules for selecting the batch size may also be used depending on the actual application. For example, the predetermined batch size selection rule may add one or more additional conditions.

With the batch size selection method of the present application, a predetermined batch size can be selected, and multiple layers of the neural network can process data in batches with that predetermined batch size.

The method presented in the present application may be used in the training phase of a model to determine the batch size to be used during training of the model. The method presented in this application can also be used in the inference phase of the model to inference data batch size of samples at one time.

Validation is performed using the method proposed in this application on the computational performance of the inception v3 model. The batch size candidates are natural numbers in the interval [2,8] and are evaluated using the computational density improvement index Δ shown in Equation (10). The evaluation results obtained using the present method are shown in Table 1, and a batch size of 6 is the preferred value in the [2,8] interval using the present method.

TABLE 1

| Batch Size Candidate | Computational Density Improvement Index Δ |
|---|---|
| 2 | 1.25e−09 |
| 3 | 1.80e−09 |
| 4 | 1.75e−09 |
| 5 | 1.88e−09 |
| 6 | 1.97e−09 |
| 7 | 1.75e−09 |
| 8 | 1.62e−09 |

The actual validation results are shown in Table 2. In Table 2, the meaning of “Cycle” is the instruction cycles required for the inference of the neural network model under the current batch size candidate, and the meaning of “Cycle/batch” is the instruction cycles required when averaged to each batch.

According to Table 2, the computational performance of the model is optimal for a batch size of 6 in the actual test, which is consistent with the method proposed in this application.

TABLE 2

| Batch Size Candidate | Cycles | Cycle/Batch |
|---|---|---|
| 2 | 17790121 | 8,895,060 |
| 3 | 22574918 | 7,524,972 |
| 4 | 28584960 | 7,146,240 |
| 5 | 34536531 | 6,907,306 |
| 6 | 40456642 | 6,742,773 |
| 7 | 47602127 | 6,800,303 |
| 8 | 54533058 | 6,816,632 |

It will be appreciated that on-chip memory and off-chip memory may refer to GPU memory hardware, and the present application is not limited thereto. As previously described, the on-chip memory and the off-chip memory may refer to a first memory that substantially occupies no amount of memory access and a second memory occupying the amount of memory access, respectively. For example, the on-chip memory has an access rate at a level of nanosecond and the off-chip memory at a level of microsecond.

It will be appreciated that the total memory access amount of the neural network may include the amount of memory access of each layer of the neural network. In some embodiments, the amount of computation of the neural network may reside primarily in the convolutional layers of the neural network, and determining the total memory access amount of the neural network may include at least determining the total memory access amount of the convolutional layers. In yet further embodiments, the total memory access amount of the neural network may comprise the total memory access amount obtained by accumulating the amount of memory access of different layers weighted with different weights, and the different weights may be artificially determined based on experience.

The present application takes into account the overall inter-layer relationship and increases the overall computational density of the model by finding a suitable batch size value, which improves the overall computational performance. Moreover, when performing performance analysis, the present application takes into account the relationship between former and latter layers, the space limitation of the on-chip memory, etc. which is of strong practical significance.

Another aspect of the present application provides a computer-readable storage medium, in which instructions are stored. When the instructions are executed by the processor, the processor is configured to execute any of the data processing methods above. The computer-readable medium referred to in this application include various types of computer storage medium, which can be any available medium that can be accessed by a general-purpose or special-purpose computer. For example, computer-readable medium may include RAM, ROM, EPROM, E2PROM, registers, hard disks, removable disks, CD-ROM or other optical disk memory, disk memory or other magnetic storage devices, or any other temporary or non-temporary medium which can be used to carry or store desired program code units in the form of instructions or data structures, and which can be accessed by a general-purpose or special-purpose computer, or a general-purpose or special-purpose processor. For example, the disk used in this application usually copies data magnetically, while the disk uses laser to copy data optically. The above combination should also be included in the protection scope of computer-readable medium. The exemplary storage medium is coupled to the processor such that the processor can read and write information from/to the storage medium. Alternatively, the storage medium can be integrated into the processor. The processor and storage medium can reside in the ASIC.

It should be noted that although several steps of the data processing method for a neural network are mentioned in the above detailed description, such division is exemplary and not mandatory. Practically, according to the embodiments of the present application, the features and functions of two or more modules described above can be embodied in one module. In contrast, the features and functions of a module described above can be further divided into multiple modules to be embodied.

Those of ordinary skill in the art can understand and implement other changes to the disclosed embodiments by studying the description, the content of the disclosure, the drawings and the appended claims. In the claims, the word “comprise” does not exclude other elements and steps, and the word “a” and “an” do not exclude plurals. In the actual application of this application, one part may perform the functions of multiple technical features cited in the claims. Any reference signs in the claims should not be construed as limiting the scope.

1. A data processing method for a neural network, wherein the neural network is implemented by a computing device and comprises a plurality of layers, the computing device comprises a first memory and a second memory, weight data of each layer of the plurality of layers is stored in the second memory, input data and output data of each layer of the plurality of layers have respective predetermined storage locations, the predetermined storage locations being the first memory or the second memory, and the method comprises:
performing batch processing by each layer of the plurality of layers to the input data and weight data of the layer with a predetermined batch size; wherein the predetermined batch size is determined using the following steps:
determining, according to the predetermined storage locations corresponding to the input data and the output data of each layer of the plurality of layers, and a relationship between a required storage space and a storage space of the predetermined storage locations, actual storage locations of the input data and the output data of each layer when data is processed in batches using batch size candidates;
determining, according to the determined actual storage locations, respective memory access conditions of the second memory for each layer of the plurality of layers when data is processed in batches using the batch size candidates;
determining, according to the determined respective memory access conditions corresponding to the batch size candidates, respective total memory access amounts of the neural network corresponding to the batch size candidates; and
selecting, according to the respective total memory access amounts of the neural network corresponding to the batch size candidates and a predetermined batch size selection rule, the predetermined batch size from the batch size candidates.

2. The data processing method according to claim 1, wherein in the step of selecting the predetermined batch size from the batch size candidates, the predetermined batch size selection rule comprises: selecting the predetermined batch size to maximize a computational density of the data processing performed by the neural network.

3. The data processing method according to claim 1, wherein the predetermined storage locations of the input data and the output data of a layer of the neural network are both the second memory; and wherein the input data of the layer is read from the second memory, and the output data of the layer is stored in the second memory.

4. The data processing method according to claim 1, wherein the predetermined storage locations of the input data and the output data of a layer of the neural network are the second memory and the first memory, respectively; and wherein the input data of the layer is read from the second memory; and if a storage space of the first memory is capable of accommodating the output data of the layer, the output data of the layer is stored in the first memory, otherwise the output data of the layer is stored in the second memory.

5. The data processing method according to claim 1, wherein the predetermined storage locations of the input data and the output data of a layer of the neural network are the first memory and the second memory, respectively; and wherein if a storage space of the first memory is capable of accommodating the input data of the layer, the input data of the layer is read from the first memory, otherwise the input data of the layer is read from the second memory; and the output data of the layer is stored in the second memory.

6. The data processing method according to claim 1, wherein the predetermined storage locations of the input data and the output data of a layer of the neural network are both the first memory; and wherein if a storage space of the first memory is larger than a greater one of a storage space occupied by the input data of the layer and a storage space occupied by the output data of the layer, the input data of the layer is read from the first memory, and the output data of the layer is stored in the first memory, otherwise the input data of the layer is read from the second memory, and the output data of the layer is stored in the second memory.

7. The data processing method according to claim 1, wherein selecting, according to the respective total memory access amounts of the neural network corresponding to the batch size candidates and a predetermined batch size selection rule, the predetermined batch size from the batch size candidates comprises:
calculating, for a batch size candidate N of the batch size candidates, a total memory access amount D_{batch}_N when N data samples are processed in a batch and a total memory access amount D_{non_batch}_N when N data samples are processed individually, respectively, to determine a computational density improvement index Δ, wherein
$$Δ = N * ( \frac{1}{{D}_{batch} \_N} - \frac{1}{{D}_{non \_ batch} \_N} ) ,$$
wherein N is a positive integer greater than 1, and
selecting, among the batch size candidates, a batch size candidate that maximizes the computational density improvement index Δ as the predetermined batch size.

8. The data processing method according to claim 1, wherein the first memory is an on-chip memory, and the second memory is an off-chip memory.

9. A method for determining a batch size for a neural network to process data in batches, wherein the neural network is implemented by a computing device and comprises a plurality of layers, the computing device comprises a first memory and a second memory, weight data of each layer of the plurality of layers is stored in the second memory, input data and output data of each layer of the plurality of layers have respective predetermined storage locations, the predetermined storage locations being the first memory or the second memory, and the method comprises:
determining, according to the predetermined storage locations corresponding to the input data and the output data of each layer of the plurality of layers, and a relationship between a required storage space and a storage space of the predetermined storage locations, actual storage locations of the input data and the output data of each layer when data is processed in batches using batch size candidates;
determining, according to the determined actual storage locations, respective memory access conditions of the second memory for each layer of the plurality of layers when data is processed in batches using the batch size candidates;
determining, according to the determined respective memory access conditions corresponding to the batch size candidates, respective total memory access amounts of the neural network corresponding to the batch size candidates; and
selecting, according to the respective total memory access amounts of the neural network corresponding to the batch size candidates and a predetermined batch size selection rule, a predetermined batch size from the batch size candidates.

10. The method according to claim 9, wherein in the step of selecting a predetermined batch size from the batch size candidates, the predetermined batch size selection rule comprises: selecting the predetermined batch size to maximize a computational density of a data processing performed by the neural network.

11. The method according to claim 9, wherein the predetermined storage locations of the input data and the output data of a layer of the neural network are both the second memory; and wherein the input data of the layer is read from the second memory, and the output data of the layer is stored in the second memory.

12. The method according to claim 9, wherein the predetermined storage locations of the input data and the output data of a layer of the neural network are the second memory and the first memory, respectively; and wherein the input data of the layer is read from the second memory; and if a storage space of the first memory is capable of accommodating the output data of the layer, the output data of the layer is stored in the first memory, otherwise the output data of the layer is stored in the second memory.

13. The method according to claim 9, wherein the predetermined storage locations of the input data and the output data of a layer of the neural network are the first memory and the second memory, respectively; and wherein if a storage space of the first memory is capable of accommodating the input data of the layer, the input data of the layer is read from the first memory, otherwise the input data of the layer is read from the second memory; and the output data of the layer is stored in the second memory.

14. The method according to claim 9, wherein the predetermined storage locations of the input data and the output data of a layer of the neural network are both the first memory; and wherein if a storage space of the first memory is larger than a greater one of a storage space occupied by the input data of the layer and a storage space occupied by the output data of the layer, the input data of the layer is read from the first memory, and the output data of the layer is stored in the first memory, otherwise the input data of the layer is read from the second memory, and the output data of the layer is stored in the second memory.

15. The method according to claim 9, wherein: selecting, according to the respective total memory access amounts of the neural network corresponding to the batch size candidates and a predetermined batch size selection rule, a predetermined batch size from the batch size candidates comprises:
calculating, for a batch size candidate N of the batch size candidates, a total memory access amount D_{batch}_N when N data samples are processed in a batch and a total memory access amount D_{non_batch}_N when N data samples are processed individually, respectively, to determine a computational density improvement index Δ, wherein
$$Δ = N * ( \frac{1}{{D}_{batch} \_N} - \frac{1}{{D}_{non \_ batch} \_N} ) ,$$
wherein N is a positive integer greater than 1, and
selecting, among the batch size candidates, a batch size candidate that maximizes the computational density improvement index Δ as the predetermined batch size.

16. The method according to claim 9, wherein the first memory is an on-chip memory, and the second memory is an off-chip memory.
